(19) United States
(12) Patent Application Publication
(10) Pub. No.: US 2025/0149712 A1
(43) Pub. Date: May 8, 2025

(54) POWER STORAGE DEVICE

(71) Applicant: TOYOTA JIDOSHA KABUSHIKI KAISHA, Aichi-ken (JP)

(72) Inventors: Eiji YOSHIDA, Seto-shi (JP); Ryuma OSAKA, Toyota-shi (JP); Ryo IWASAKI, Nukata-gun (JP); Naoki TANI, Nagoya-shi (JP); Masanori KODERA, Toyota-shi (JP)

(21) Appl. No.: 18/931,056

(22) Filed: Oct. 30, 2024

(30) Foreign Application Priority Data
Nov. 2, 2023 (JP) 2023-188583

(51) Int. Cl. H01M 50/242; B60R 13/08; B60R 16/04; H01M 50/209; H01M 50/271; H01M 50/289

(52) U.S. Cl. CPC H01M 50/242; B60R 13/0861; B60R 16/04; H01M 50/209; H01M 50/271; H01M 50/289; H01M 2220/20

(57) ABSTRACT

A power storage device includes: a power storage stack including a plurality of power storage cells; an accommodation case that accommodates the power storage stack; an accommodation case that accommodates the power storage stack, the accommodation case including an upper cover that covers the power storage stack; an outer elastic body composed of an elastic material and provided on an outer surface of the upper cover; and an inner elastic body composed of an elastic material and provided on an inner surface of the upper cover, wherein when the inner elastic body is viewed from a position separated in a direction of arrangement of the outer elastic body and the inner elastic body, the inner elastic body is disposed to at least partially overlap with the outer elastic body.

### CROSS REFERENCE TO RELATED APPLICATIONS

This nonprovisional application is based on Japanese Patent Application No. 2023-188583 filed on Nov. 2, 2023 with the Japan Patent Office, the entire contents of which are hereby incorporated by reference.

### BACKGROUND

### Field

The present disclosure relates to a power storage device.

### Description of the Background Art

For example, Japanese Patent Laying-Open No. 10-69893 discloses a pack battery including: a case that accommodates a battery; and a rubber sponge provided on an inner surface of an upper case in the case.

### SUMMARY

When a power storage device such as the one described in Japanese Patent Laying-Open No. 10-69893 is mounted on a vehicle, it is required to reduce vibration of the power storage device with respect to the vehicle. Further, it is concerned that when a downward load is input to the power storage device from above, the upper cover may be brought into contact with the power storage stack.

An object of the present disclosure is to provide a power storage device so as to suppress vibration of the power storage device with respect to a vehicle and suppress an upper cover from being brought into contact with a power storage stack.

A power storage device according to the present disclosure includes: a power storage stack including a plurality of power storage cells; an accommodation case that accommodates the power storage stack, the accommodation case including an upper cover that covers the power storage stack; an outer elastic body composed of an elastic material and provided on an outer surface of the upper cover; and an inner elastic body composed of an elastic material and provided on an inner surface of the upper cover, wherein when the inner elastic body is viewed from a position separated in a direction of arrangement of the outer elastic body and the inner elastic body, the inner elastic body is disposed to at least partially overlap with the outer elastic body.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram schematically showing a vehicle 2 including a power storage device 1 according to the present embodiment.

FIG. 2 is a perspective view schematically showing the power storage device according to one embodiment of the present disclosure.

FIG. 3 is an exploded perspective view of power storage device 1 shown in FIG. 2.

FIG. 4 is a cross sectional view along a line IV-IV shown in FIG. 2.

FIG. 5 is a diagram when each of an outer elastic body 500 and an inner elastic body 600 is viewed in a plan view from a position separated in an upward direction from each of outer elastic body 500 and inner elastic body 600.

FIG. 6 is a plan view showing a first modification of each of the outer elastic body and the inner elastic body.

FIG. 7 is a plan view showing a second modification of each of the outer elastic body and the inner elastic body.

### DESCRIPTION OF THE PREFERRED EMBODIMENTS

Embodiments of the present disclosure will be described with reference to figures. It should be noted that in the figures described below, the same or corresponding members are denoted by the same reference characters.

FIG. 1 is a diagram schematically showing a vehicle 2 including a power storage device 1 according to the present embodiment. Power storage device 1 is mounted, for example, below a bottom portion 10 provided at a lower portion of vehicle 2. It should be noted that bottom portion 10 of vehicle 2 means a portion below a floor panel when vehicle 2 includes the floor panel. Further, when vehicle 2 includes no floor panel, bottom portion 10 of vehicle 2 means a portion between or below side members extending in a vehicle width direction of vehicle 2.

It should be noted that in FIG. 1 and the like, a first direction L1 indicates the vehicle width direction of vehicle 2, and a second direction L2 indicates a frontward/rearward direction of vehicle 2.

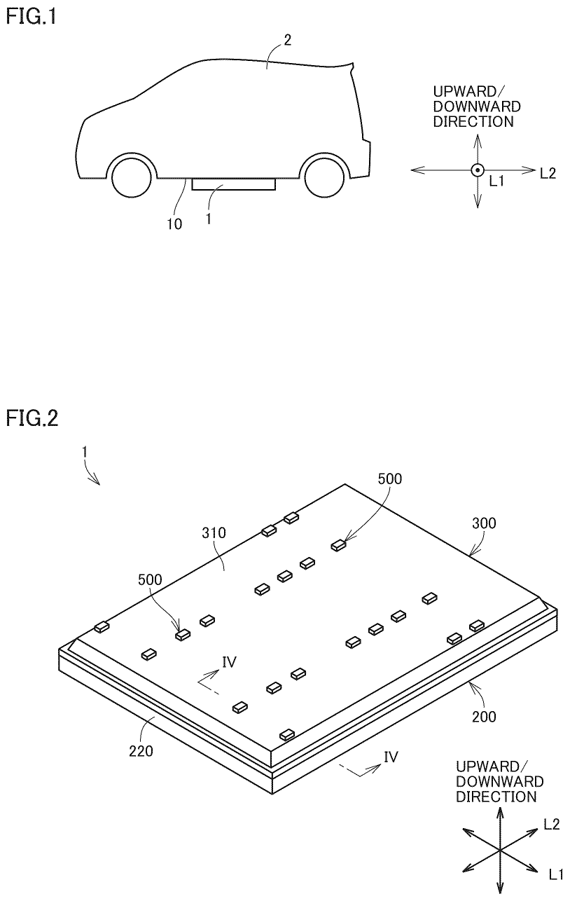

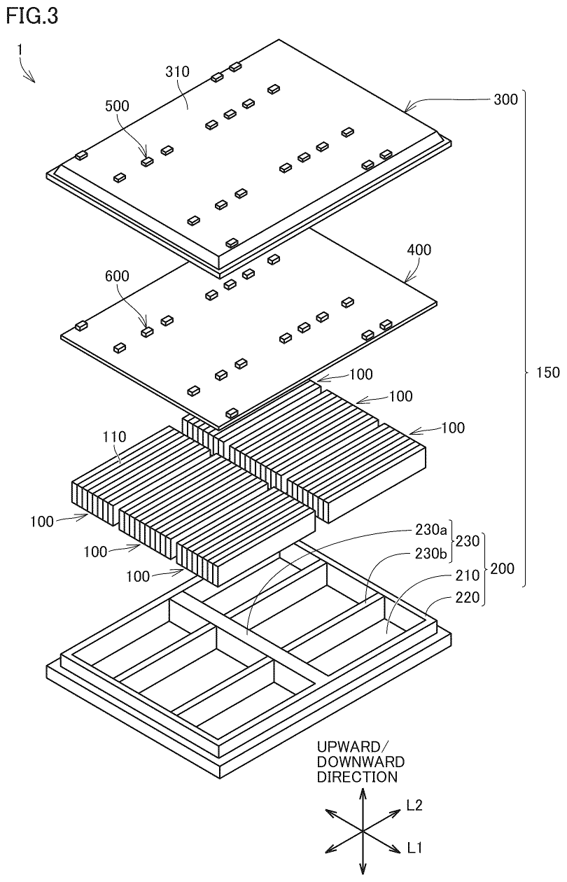

FIG. 2 is a perspective view schematically showing the power storage device according to one embodiment of the present disclosure. FIG. 3 is an exploded perspective view of power storage device 1 shown in FIG. 2.

As shown in FIG. 3, power storage device 1 includes at least one power storage stack 100, an accommodation case 150, a pressing plate 400, at least one outer elastic body 500, and at least one inner elastic body 600. In the present embodiment, power storage device 1 includes six power storage stacks 100. However, the number of power storage stacks 100 is not limited to six.

The plurality of power storage stacks 100 are arranged at intervals in the first direction and are arranged at intervals in second direction L2. It should be noted that each of power storage stacks 100 includes a plurality of power storage cells 110 arranged side by side in the first direction.

Each of power storage cells 110 is formed to be elongated in second direction L2. Power storage cell 110 is, for example, a lithium ion battery.

Accommodation case 150 includes a contour body 200 and an upper cover 300. Contour body 200 is opened in the upward direction. Contour body 200 has a bottom plate 210, a peripheral wall 220, and a partition wall 230. Contour body 200 accommodates the plurality of power storage stacks 100. Each of power storage stacks 100 is accommodated to be surrounded on the four sides by partition wall 230 and peripheral wall 220. Thus, partition wall 230 is disposed beside power storage stack 100.

Bottom plate 210 supports each of power storage stacks 100. Bottom plate 210 may include a cooling plate that is in contact with a bottom portion of each power storage stack 100. Peripheral wall 220 is formed to extend upward from a peripheral edge portion of bottom plate 210.

Partition wall 230 is constituted of a first partition wall 230a and a plurality of second partition walls 230b. It should be noted that partition wall 230 is an example of a “load transmission portion” in the present disclosure.

First partition wall 230a is formed on an upper surface of bottom plate 210 so as to extend in first direction L1. First partition wall 230a is disposed to extend through the center of bottom plate 210 in second direction L2. End surfaces of first partition wall 230a in first direction L1 are joined to peripheral wall 220. The upper surface of first partition wall 230a is located on the same plane as the upper surface of peripheral wall 220.

Each of the plurality of second partition walls 230b is formed to rise from the upper surface of bottom plate 210 and extend in second direction L2. The plurality of second partition walls 230b are disposed to divide bottom plate 210 into three in first direction L1. One end surface of end surfaces of second partition wall 230b in second direction L2 is joined to peripheral wall 220, and the other end surface of the end surfaces of second partition wall 230b in second direction L2 is joined to first partition wall 230a. The upper surface of second partition wall 230b is located on the same plane as the upper surface of peripheral wall 220.

Upper cover 300 is opened downward. An outer peripheral edge of upper cover 300 and an outer peripheral edge of contour body 200 coincide with each other. The outer peripheral edge of upper cover 300 is fixed to contour body 200 by a bolt or the like. Upper cover 300 covers the plurality of power storage stacks 100. Upper cover 300 and contour body 200 accommodate power storage stacks 100. Upper cover 300 includes a top wall 310 located above the plurality of power storage stacks 100. Top wall 310 may be formed to have a flat plate shape.

Pressing plate 400 is located on peripheral wall 220 and the upper surface of partition wall 230. Pressing plate 400 is disposed over the plurality of power storage stacks 100 and partition wall 230. Pressing plate 400 presses power storage stacks 100 toward bottom plate 210. Pressing plate 400 is formed to have such a size that the outer peripheral edge portion of the pressing plate is in contact with the upper surface of peripheral wall 220. Pressing plate 400 is formed to have a flat plate shape. Pressing plate 400 is composed of a synthetic resin or the like.

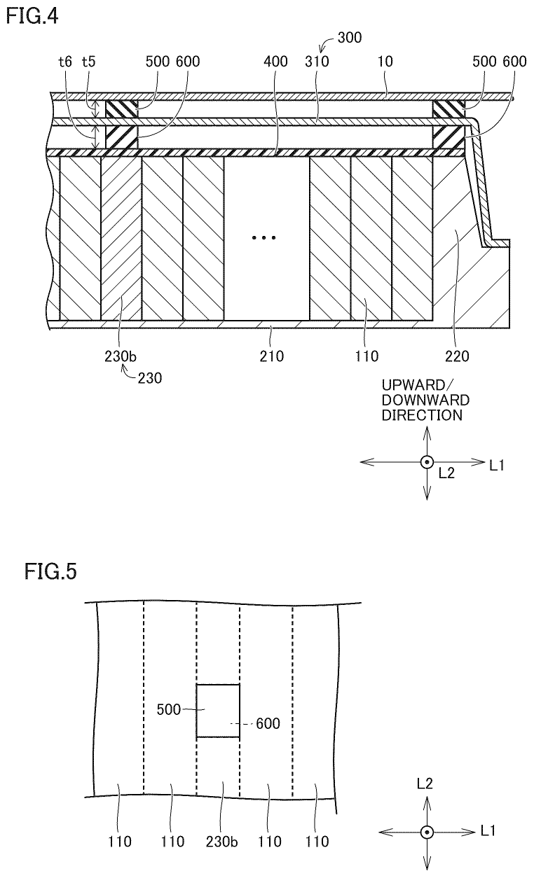

FIG. 4 is a cross sectional view along a line IV-IV shown in FIG. 2. In FIG. 4, each of outer elastic bodies 500 is provided on the upper surface of top wall 310. Each of outer elastic bodies 500 is composed of an elastic material such as urethane. Each of outer elastic bodies 500 is formed to have a flat rectangular parallelepiped shape. The plurality of outer elastic bodies 500 are arranged at intervals in each of first direction L1 and second direction L2. Outer elastic bodies 500 are located above peripheral wall 220 and second partition wall 230b. Outer elastic bodies 500 are sandwiched between bottom portion 10 and top wall 310.

In FIG. 4, each of inner elastic bodies 600 is provided on the lower surface of upper cover 300. Each of inner elastic bodies 600 is composed of an elastic material such as urethane. Each of inner elastic bodies 600 is formed to have a flat rectangular parallelepiped shape. Inner elastic body 600 may be formed to have the same shape as that of outer elastic body 500 in a plane formed by first direction L1 and second direction L2. The plurality of inner elastic bodies 600 are arranged at intervals in each of first direction L1 and second direction L2.

Outer elastic body 500 and inner elastic body 600 are arranged in the upward/downward direction (direction of arrangement). FIG. 5 is a diagram when each of outer elastic body 500 and inner elastic body 600 is viewed in a plan view from a position separated in the upward direction from each of outer elastic body 500 and inner elastic body 600.

In the example shown in FIG. 5, the shape of outer elastic body 500 when viewed in a plan view is substantially the same as the shape of inner elastic body 600 when viewed in a plan view, and outer elastic body 500 and inner elastic body 600 overlap with each other.

Returning to FIG. 4, each of inner elastic bodies 600 is located above peripheral wall 220 and second partition wall 230b. Inner elastic body 600 is sandwiched between top wall 310 of upper cover 300 and pressing plate 400. It should be noted that a thickness t6 of each of inner elastic bodies 600 is thicker than a thickness t5 of each of outer elastic bodies 500.

A spring constant [N/mm] of each of inner elastic bodies 600 is larger than a spring constant [N/mm] of each of outer elastic bodies 500. It should be noted that the term “spring constant” includes a static spring constant and a dynamic spring constant. A method of measuring each of the static spring constant and the dynamic spring constant is based on JIS K 6385. That is, the spring constant is calculated based on a relation between a load applied to each of elastic bodies 500, 600 and deflection of each of elastic bodies 500, 600 on that occasion.

A hardness (type C) of each of inner elastic bodies 600 is larger than a hardness (type C) of each of outer elastic bodies 500. A method of measuring the hardness (type C) is based on JIS K 7312. That is, the hardness is calculated based on reaction force applied to a needle from a test piece of each of elastic bodies 500, 600 when the test piece is pressed by the needle.

According to the embodiment of the present disclosure, peripheral wall 220 and partition wall 230 are formed in contour body 200. Outer elastic body 500 and inner elastic body 600 are located above peripheral wall 220 and partition wall 230. Further, outer elastic body 500 is located on the lower surface of bottom portion 10 of vehicle 2. Thus, with outer elastic bodies 500 and the plurality of inner elastic bodies 600, vibration propagated from vehicle 2 can be suppressed by power storage device 1 mounted on bottom portion 10.

According to the embodiment of the present disclosure, since inner elastic body 600 having a relatively large spring constant is provided on the inner surface of upper cover 300, top wall 310 can be suppressed from hitting against power storage stack 100 when a downward external force is applied to top wall 310 of upper cover 300.

According to the embodiment of the present disclosure, since partition wall 230 is formed to extend upward from the upper surface of bottom plate 210, a load input to upper cover 300 in the downward direction can be transmitted to bottom plate 210 through outer elastic body 500 and inner elastic body 600.

According to the embodiment of the present disclosure, since pressing plate 400 is disposed over the plurality of power storage stacks 100 and partition wall 230, pressing plate 400 can press power storage stacks 100 toward bottom plate 210. Thus, vibration propagated from vehicle 2 can be suppressed by power storage device 1 mounted on bottom portion 10.

In the above-described embodiment, it has been illustratively described that inner elastic body 600 is formed to have the same shape as that of outer elastic body 500 in the plane formed by first direction L1 and second direction L2, but the present disclosure is not limited thereto.

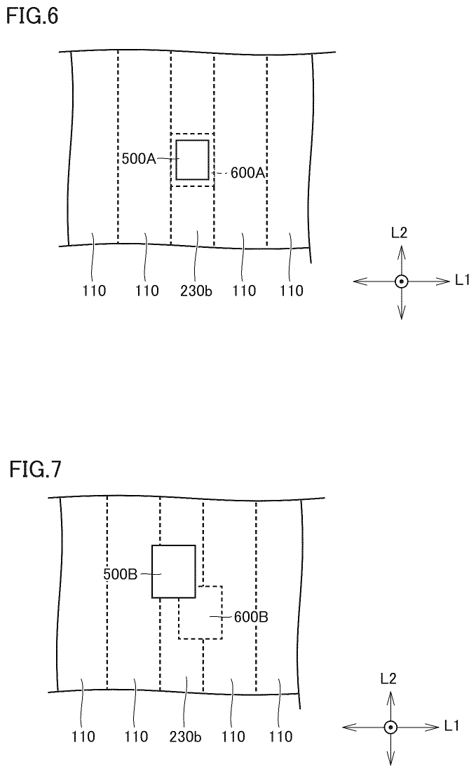

FIG. 6 is a plan view showing a first modification of each of the outer elastic body and the inner elastic body. In the example shown in FIG. 6, the power storage device includes an outer elastic body 500A and an inner elastic body 600A. When each of outer elastic body 500A and inner elastic body 600A is viewed in a plan view from above, outer elastic body 500A is located inside inner elastic body 600A.

Thus, inner elastic body 600A is formed to be larger than outer elastic body 500A when viewed in a plan view. That is, inner elastic body 600 may be formed to have a shape different from that of outer elastic body 500 in the plane formed by first direction L1 and second direction L2.

In the above-described embodiment, it has been illustratively described that outer elastic body 500 and inner elastic body 600 overlap with each other such that their centers coincide with each other in the plane formed by first direction L1 and second direction L2, but the present disclosure is not limited thereto.

FIG. 7 is a plan view showing a second modification of each of the outer elastic body and the inner elastic body. In the example shown in FIG. 7, the power storage device includes an outer elastic body 500B and an inner elastic body 600B.

When each of outer elastic body 500B and inner elastic body 600B is viewed in a plan view from a position separated in the upward direction, inner elastic body 600B may be disposed to at least partially overlap with outer elastic body 500B.

It has been illustratively described that outer elastic body 500 is located above peripheral wall 220 and second partition wall 230b in the above-described embodiment, but the present disclosure is not limited thereto. For example, outer elastic body 500 may be located above first partition wall 230a. The same applies to inner elastic body 600.

Further, as shown in FIG. 7, outer elastic body 500B may be located to overlap with at least a portion of second partition wall 230b in the upward/downward direction. The same applies to a positional relation between outer elastic body 500B and peripheral wall 220 in the upward/downward direction.

Similarly, inner elastic body 600B may overlap with at least a portion of second partition wall 230b in the upward/downward direction. The same applies to a positional relation between inner elastic body 600B and peripheral wall 220 in the upward/downward direction.

It has been illustratively described that thickness t6 of inner elastic body 600 is thicker than thickness t5 of each outer elastic body 500 in the above-described embodiment, but the present disclosure is not limited thereto. For example, thickness t6 of each inner elastic body 600 may be equal to or less than thickness t5 of each outer elastic body 500.

Although the embodiments of the present disclosure have been described and illustrated in detail, it is clearly understood that the same is by way of illustration and example only and is not to be taken by way of limitation. The scope of the present disclosure is defined by the terms of the claims, and is intended to include any modifications within the scope and meaning equivalent to the terms of the claims.

What is claimed is:

1. A power storage device comprising:
a power storage stack including a plurality of power storage cells;
an accommodation case that accommodates the power storage stack, the accommodation case including an upper cover that covers the power storage stack;
an outer elastic body composed of an elastic material and provided on an outer surface of the upper cover; and
an inner elastic body composed of an elastic material and provided on an inner surface of the upper cover, wherein
when the inner elastic body is viewed from a position separated in a direction of arrangement of the outer elastic body and the inner elastic body, the inner elastic body is disposed to at least partially overlap with the outer elastic body.

2. The power storage device according to claim 1, wherein the inner elastic body has a spring constant larger than a spring constant of the outer elastic body.

3. The power storage device according to claim 1, wherein a thickness of the inner elastic body is thicker than a thickness of the outer elastic body.

4. The power storage device according to claim 1, wherein
the power storage device is disposed below a bottom portion provided at a lower portion of the vehicle, and
the outer elastic body is sandwiched between the upper cover and the bottom portion.

5. The power storage device according to claim 4, wherein
the accommodation case has
a bottom plate, and
a load transmission portion that transmits, to the bottom plate, a load input to the upper cover in a downward direction,
the load transmission portion rises from the bottom plate and is disposed beside the power storage stack, and
the inner elastic body is located above the load transmission portion.

6. The power storage device according to claim 5, further comprising a pressing plate that presses the power storage stack toward the bottom plate, wherein
the pressing plate is disposed over the power storage stack and the load transmission portion, and
the inner elastic body is sandwiched between the upper cover and the pressing plate.
